(19) United States
(12) Patent Application Publication
(10) Pub. No.: US 2015/0193090 A1
(43) Pub. Date: Jul. 9, 2015

(54) METHOD AND SYSTEM FOR APPLICATION CATEGORY USER INTERFACE TEMPLATES

(71) Applicant: Ford Global Technologies, LLC, Dearborn, MI (US)

(72) Inventors: Joey Ray GROVER, Madison Heights, MI (US); Philip Joseph DANNE, Royal Oak, MI (US)

(73) Assignee: Ford Global Technologies, LLC, Dearborn, MI (US)

(21) Appl. No.: 14/147,708

(22) Filed: Jan. 6, 2014

(51) Int. Cl. G06F 3/0481; G06F 3/0484

(52) U.S. Cl. CPC G06F 3/0481; G06F 3/04842

(57) ABSTRACT

A computer-implemented method includes matching application-identifying information of an application to one of a plurality of available user interface templates, each user interface template defining a presentation of common user interface elements included in each of the templates; and providing content from the application in the user interface formatted according to the presentation of the matching user interface template.

### TECHNICAL FIELD

The present disclosure generally relates to vehicle infotainment systems, and more particularly, to systems and methods of providing user interfaces on infotainment systems.

### BACKGROUND

U.S. Pat. No. 7,324,833 generally discloses an audio system and method. A system may include, for example, an electronic device having a display, a memory, an audio file player, and a housing component at least partially defining a cavity in which the memory and the audio file player are secured. In one embodiment, the electronic device may be a portable MP3 player. The system may also include a processor or playlist engine that can maintain a first playlist and a second playlist. In practice, the first playlist may include a selection of audio content having a corresponding audio file saved in the memory of the electronic device. In one embodiment, the system may also include an automobile having an automobile sound system that has a speaker and an in dash sound system component, which may be removably coupled to the electronic device via a cable. The in dash sound system component may have a selector, which may be, for example, a button, that allows a user to select the first playlist for outputting via the speaker. The cable interconnecting the electronic device and the in dash sound system component may be capable of providing power to the electronic device in addition to communicatively coupling the electronic device to the automobile sound system.

U.S. Pat. No. 7,634,228 generally discloses a media managing method. A method links a graphical interface soft button with a media file saved in a memory system of a portable electronic device, maintains a collection of information that represents the graphical interface soft button in the memory system, and communicates at least some of the collection to a different electronic device in order to allow a user to view a representation of the graphical interface soft button on an associated display of the different electronic device. The method further receives a signal to begin playing the media file in response to a selection of the representation.

U.S. Pat. No. 8,346,310 generally discloses a vehicle-based computing apparatus including a computer processor in communication with persistent and non-persistent memory. The apparatus also includes a local wireless transceiver in communication with the computer processor and configured to communicate wirelessly with a wireless device located at the vehicle. The processor is operable to receive, through the wireless transceiver, a connection request sent from a nomadic wireless device, the connection request including at least a name of an application seeking to communicate with the processor. The processor is further operable to receive at least one secondary communication from the nomadic device, once the connection request has been processed. The secondary communication is at least one of a speak alert command, a display text command, a create phrase command, and a prompt and listen command.

U.S. Patent Application Publication 2003/0046401 generally discloses a method, system, and computer-readable medium are described for dynamically determining an appropriate user interface (“UI”) to be provided to a user. In some situations, the determining is to dynamically modify a UI being provided to a user of a wearable computing device so that the current UI is appropriate for a current context of the user. In order to dynamically determine an appropriate UI, various types of UI needs may be characterized (e. g., based on a current user's situation, a current task being performed, current I/O devices that are available, etc.) in order to determine characteristics of a UI that is currently optimal or appropriate, various existing UI designs or templates may be characterized in order to identify situations for which they are optimal or appropriate, and one of the existing UIs that is most appropriate may then be selected based on the current UI needs.

U.S. Patent Application Publication 2010/0251134 generally discloses a communications apparatus includes a processing resource arranged to support, when in use, a main application and a user interface. The apparatus, in at least one embodiment, also includes a data store and a user interface host entity arranged to access, when in use, a user interface template selectable in response to a received message. The user interface template includes an expression of a number of user interface elements. The user interface is arranged to translate the user interface template selected from the expression of the number of user interface elements into a user interface instantiation.

U.S. Patent Application Publication 2013/0231055 generally discloses a mobile arrangement, such as a mobile communication device, including a user interface (UI) configured to receive user input, a wireless data transfer interface configured to receive a command, such as a PTT (Push-to-Talk) command, sent by an RSM (Remote Speaker Microphone) device or other accessory, such as an in-car device or a headset, wirelessly connected to the mobile arrangement, and an interfacing logic configured to map the received command to a predetermined command locally providable via the user interface to a communication application running on the mobile arrangement and capable of receiving user input via the user interface so as to enable utilization of the communication application through the RSM or other accessory. Corresponding method and computer program product are presented.

### SUMMARY

In a first illustrative embodiment, a computer-implemented method includes matching application-identifying information of an application to one of a plurality of available user interface templates, each user interface template defining a presentation of common user interface elements included in each of the templates; and providing content from the application in the user interface formatted according to the presentation of the matching user interface template.

In a second illustrative embodiment, a system includes at least one controller configured to match application-identifying information of an application to one of a plurality of available user interface templates, each user interface template defining a presentation of common user interface elements included in each of the templates; and provide content from the application in the user interface formatted according to the presentation of the matching user interface template.

In a third illustrative embodiment, a non-transitory computer readable medium includes instructions configured to cause at least one controller to match application-identifying information of an application to one of a plurality of available user interface templates, each user interface template defining a presentation of common user interface elements included in each of the templates; and provide content from the application in the user interface formatted according to the presentation of the matching user interface template.

### BRIEF DESCRIPTION OF THE DRAWINGS

FIG. 1 is an exemplary block topology of a vehicle infotainment system implementing a user-interactive vehicle information display system;

FIG. 2 is an exemplary block topology of an example system for integrating one or more nomadic devices with an infotainment system;

FIG. 3A illustrates an exemplary user interface template supporting a main content section and a plurality of minor content elements;

FIG. 3B illustrates an alternate user interface template also supporting a main content section and a plurality of minor content elements, but having a different user interface layout;

FIG. 4A illustrates an exemplary user interface of a weather-type application applying the template illustrated in FIG. 3A;

FIG. 4B illustrates an exemplary user interface of a launcher-type application applying the template 300-B illustrated in FIG. 3B;

FIG. 5 illustrates an exemplary process for applying a user interface template to a nomadic application; and

FIG. 6 illustrates an exemplary process for updating a user interface of a nomadic application according to an applied user interface template.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

A vehicle may have a user interface system that may communicate with one or more nomadic devices. The user interface system may include, but is not limited to, a vehicle computing system, a display, and at least one connection apparatus to communicate with one or more nomadic devices. A user may interface with the one or more nomadic devices using the vehicle interface system. The one or more nomadic devices may contain several applications that may be compatible with the interface system for operation of a feature and/or function. The applications may be executed on the nomadic device, system, and/or a combination of both; and the output data may be presented to a user at the interface system.

The user interface system may be designed to provide safe and informative user interfaces that reflect in-vehicle-specific environmental considerations. For example, the in-vehicle user interface may utilize standardized common user interface layout designs to aid in user familiarity and speed of interaction with presented information. As another example, the in-vehicle user interface may implement restrictions on displayed content or user input when the vehicle is in motion. As yet a further example, the in-vehicle user interface may utilize hands-free voice control to allow the driver to stay focused on the road. Moreover, the in-vehicle user interface may also be designed to implement rapid acknowledgement of user input even if execution of the command is delayed, to allow the user to quickly conclude the user interface interaction and avoid prolonged addition to the driver workload. These design requirements may impose a burden on application developers to design proper in-vehicle user interfaces.

One possibility for integrating applications executed by nomadic devices into the user interface is to utilize a single common user interface form predesigned to be safe for use in the vehicle context. However, such as approach may reduce the functionality available from individual applications down to only a minimal set of features. Moreover such an approach may lack the ability for a nomadic application utilizing the common form to “brand” the user experience, via imagery or application-specific functions (e.g., “Like” button for a Facebook application).

As another possibility, each individual nomadic application may be implemented in combination with a corollary application or component installed on the user interface system that communicates with the nomadic application to support application-specific branding and functionality. However, these multiple-component solutions may be difficult to maintain or update. For example, the application may be required to keep track of which versions of the nomadic application may be compatible with what versions of the component installed on the user interface system. Moreover, if application-specific branding of functionality changes, then multiple different components may require updates. Yet further, it may be difficult for non-technical users to update the software components installed to the user interface system.

As a further possibility, the nomadic applications may be designed with an application-specific in-vehicle user interface mode. However, this necessitates additional work for the nomadic application developer to construct a second user interface suitable for in-vehicle use. Moreover, such an approach gives the nomadic developer control to create a user interface outside the control of the vehicle OEM or user interface system provider, which may not include features considered safe into be used within the in-vehicle environment.

Rather than pre-defining user interfaces on the user interface system or implementing a separate mode of a nomadic application, a common set of “templates” may be utilized on the vehicle head unit and populated with content from the nomadic application. These templates may be distinguished by the category of application (e.g., “internet radio,” “navigation,” “weather,” “traffic,” “music,” “social media,” etc.). In other cases, templates may be available for specific applications (e.g., “Pandora,” “Facebook,” etc.). The templates may also include a catch-all “generic” template to provide a user interface for any applications that do not match to one of the specific templates.

Each template may be pre-designed to be safe for use by vehicle occupants, and also to support a type of functionality useful for an application category or specific application. The templates may be indexed by application identifier or category identifier to allow the user interface system to match an application to the proper template. For example, when a nomadic application connects to the user interface system, the nomadic application may specify the application-identifying information, such as an application identifier or category identifier, and the user interface system may load an appropriate template for the initiated application based on the specified application-identifying information.

Using the loaded template, the user interface system may populate the user interface with data from the nomadic application, formatted according to the correct template. For example, the user interface system and the nomadic application may negotiate regarding various aspects of the user interface (e.g., how many buttons are available, which common functionality is available, etc.). As one possibility, user interface elements to be hidden may be updated with a special value such as zero, NULL, or some other predefined value. Using the negotiated layout, the nomadic application may dynamically update the content of the user interface elements of the in-vehicle template.

As the nomadic application is designed to use a template selected by the system, a single nomadic application implementation may work across many different in-vehicle template implementations (i.e., across multiple vehicle makes or modules, or versions of a template), without modification. Additionally, because the templates may be matched by identifier, the user interface system may be able to update the templates independent of updates to the specific application or category of applications with which the template may be utilized. Yet further, as the templates maybe updateable on the user interface system, the user interface system may be able to support future nomadic applications without knowledge of which nomadic applications will be popular or desired years into the future. Moreover, the templates may allow for an increased number of nomadic applications to be made available via in-vehicle user interfaces, as a dedicated mobile user interface does not need to be determined and developed for each nomadic application.

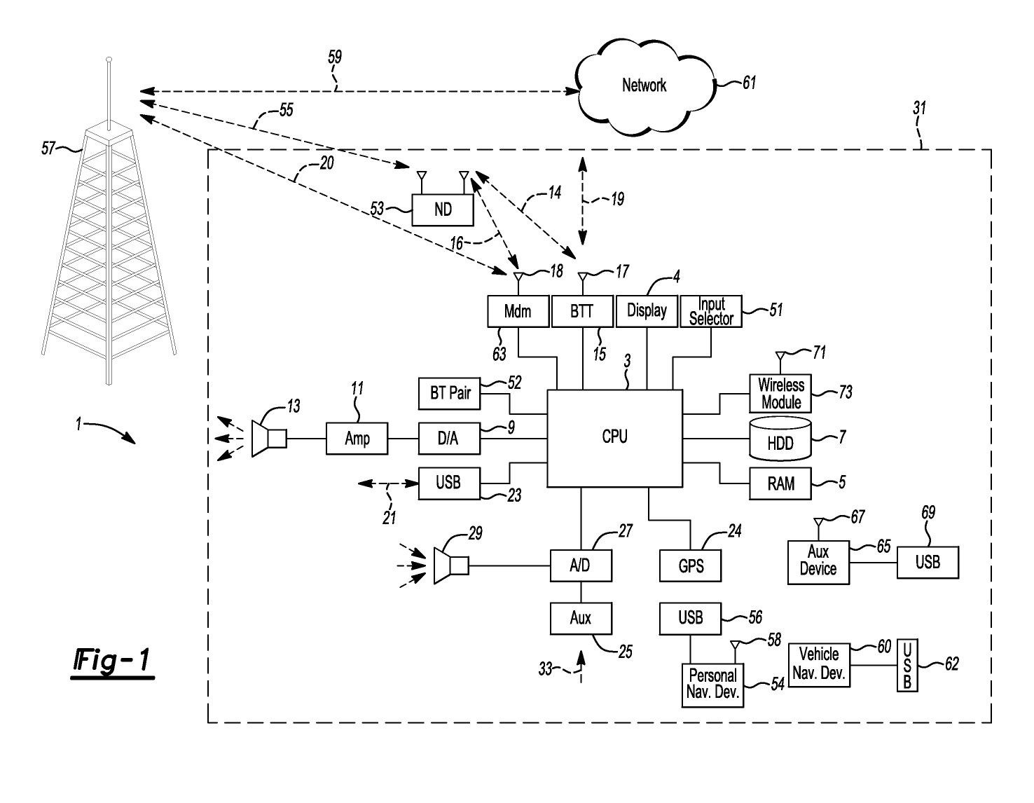

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

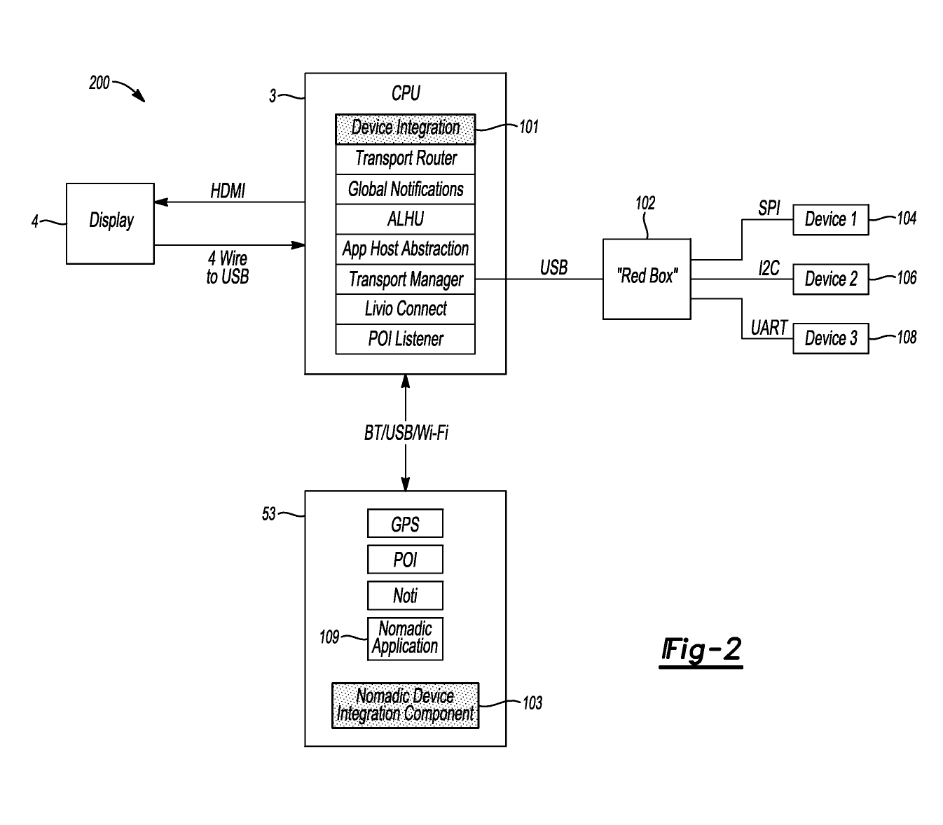

FIG. 2 is an exemplary block topology of a system for integrating one or more connected devices with the vehicle based computing system 1 (VCS). To facilitate the integration, the CPU 3 may include a device integration framework 101 configured to provide various services to the connected devices. These services may include transport routing of messages between the connected devices and the CPU 3, global notification services to allow connected devices to provide alerts to the user, application launch and management facilities to allow for unified access to applications executed by the CPU 3 and those executed by the connected devices, and point of interest location and management services for various possible vehicle 31 destinations.

As mentioned above, the CPU 3 of the VCS 1 may be configured to interface with one or more nomadic devices 53 of various types. The nomadic device 53 may further include a device integration client component 103 to allow the nomadic device 53 to take advantage of the services provided by the device integration framework 101. Applications executed by the nomadic device 53 may accordingly utilize the device integration client component 103 to interact with the CPU 3 via the device integration framework 101. As one example, a music player application on the nomadic device 31 may interact with the CPU 3 to provide streaming music through the speaker 13 or stereo system output of the VCS 1. As another example, a navigation application on the nomadic device 31 may interact with the CPU 3 to provide turn-by-turn directions for display on the screen 4 of the VCS 1.

The multiport connector hub 102 may be used to interface between the CPU 3 and additional types of connected devices other than the nomadic devices 53. The multiport connector hub 102 may communicate with the CPU 3 over various buses and protocols, such as via USB, and may further communicate with the connected devices using various other connection buses and protocols, such as Serial Peripheral Interface Bus (SPI), Inter-integrated circuit (I2C), and/or Universal Asynchronous Receiver/Transmitter (UART). The multiport connector hub 102 may further perform communication protocol translation and interworking services between the protocols used by the connected devices and the protocol used between the multiport connector hub 102 and the CPU 3. The connected devices may include, as some non-limiting examples, a radar detector 104, a global position receiver device 106, and a storage device 108.

A user of the VCS 1 may invoke a nomadic application, and the nomadic application may connect to the user interface system. As part of the application negotiation process, the nomadic application connecting to the VCS 1 may specify application-identifying information. As one example, the application-identifying information may include an application identifier that uniquely identifies the nomadic application to the VCS 1. Additionally or alternately, the application-identifying information may include a category identifier indicative of a category of application with which the application is associated (e.g., music, weather etc.).

Based on the application-identifying information, the VCS 1 may be configured to match the application to an appropriate user interface template. The matched user interface template may be loaded, and may be used to present user interface content from the application in a format suitable for the application in the vehicle 31 environment.

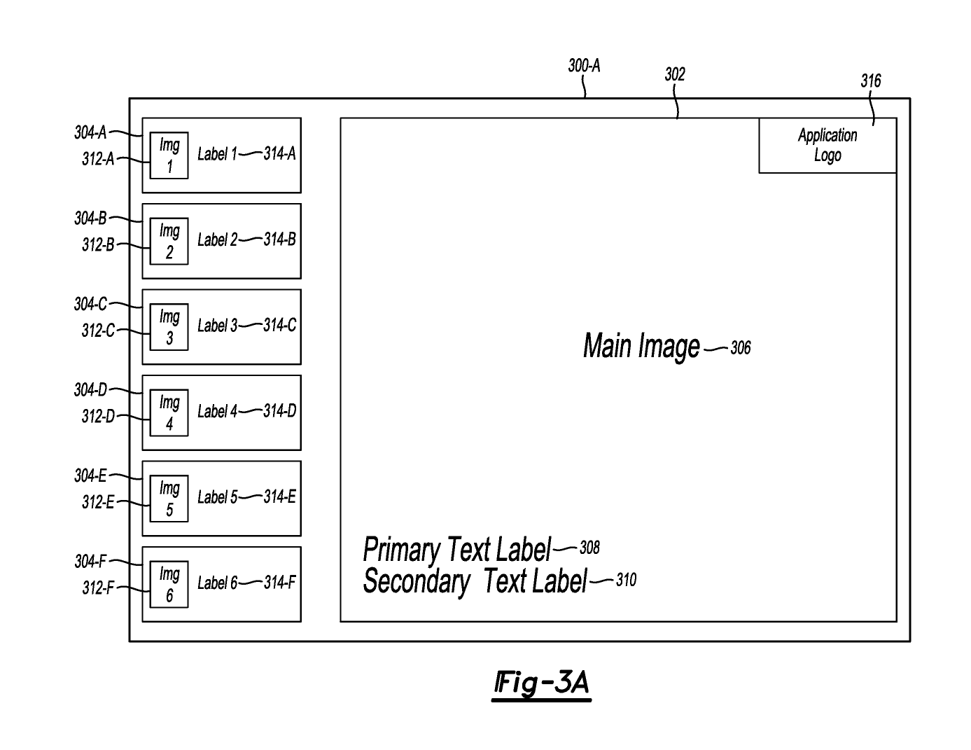

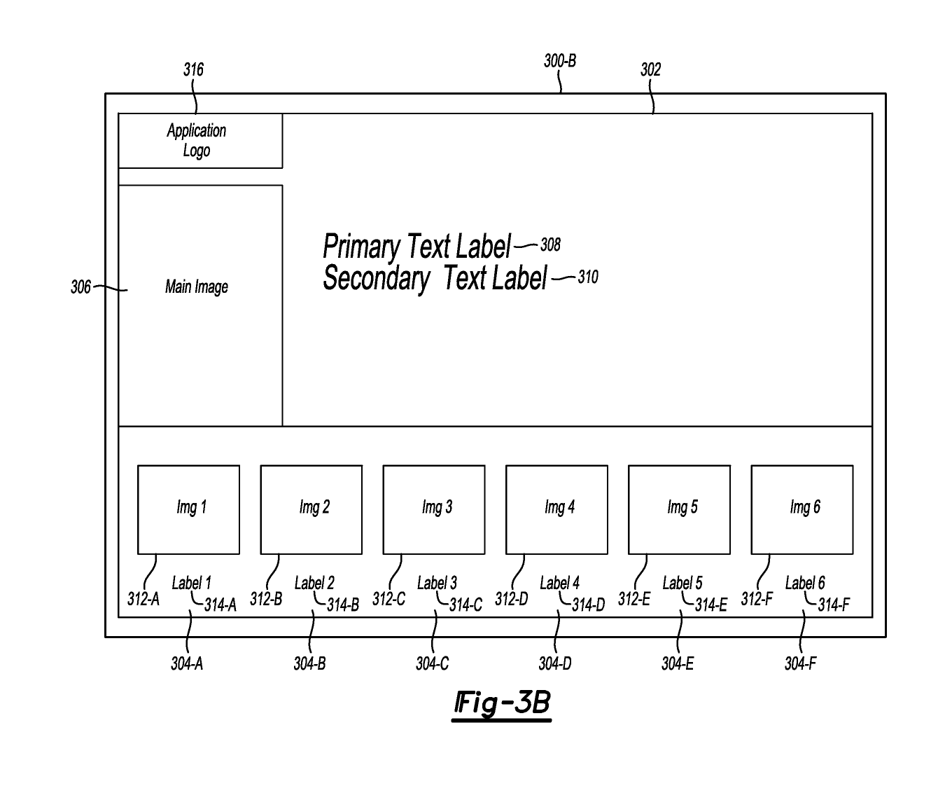

Referring to FIGS. 3A and 3B, the VCS 1 may be configured to maintain a plurality of templates 300 (e.g., the templates 300-A and 300-B). The VCS 1 may be further configured to maintain an association of application category identifiers with the stored templates 300. As one example, the template 300-A may be associated with an identifier for weather-type application, such that any nomadic applications that indicate to the VCS 1 that they are weather-type applications will be matched to the template 300-A. Thus, weather-type applications will make use of the layout of the template 300-A for presentation of data on the VCS 1. As another example, the template 300-B may be associated with an identifier for application launcher-type applications, such that any nomadic applications that indicate to the VCS 1 that they are launcher-type applications will be matched to the template 300-B. As yet another example, a template 300 may be designated as a generic template (e.g., the template 300-B, another template 300, etc.), and may be used for nomadic applications that do not otherwise match to an application template 300 of the VCS 1.

The VCS 1 may be also be configured to maintain an association of application identifiers with application-specific templates 300. The application-specific templates 300 may be used to provide customized layouts that are particularly-suited to individual applications, as opposed to templates 300 that are designed to accommodate a more general category of applications. Accordingly, selection of an application-specific template 300 may override a matching application-category template 300. For example, the Facebook application may be associated with a Facebook-specific template 300, such that when the Facebook application presents data on the VCS 1, the VCS 1 will make use of the layout of the Facebook-specific template 300 for presentation of data on the VCS 1, regardless of whether the Facebook application also matches an application category template 300.

To ensure that the application-specific templates 300 conform to user interface standards tailored to the mobile environment, the application-specific templates 300 may be validated by one or more parties. For example, a vendor of the VCS 1 or of the device integration framework 101 may validate submitted application-specific templates 300 before they may be utilized by a production VCS 1 unit in a vehicle 31. However, use of the generic or application-type templates 300 may be made by nomadic application providers, without requiring the additional approval.

FIG. 3A illustrates an exemplary user interface template 300-A supporting a main content section 302 and a plurality of minor content elements 304-A through 304-F (collectively 304). The main content section 302 may include, for example, a main image sub-element 306, a primary label sub-element 308, and a secondary label sub-element 310. Each minor content element 304 may include an image sub-element 312 and a label sub-element 314. The user interface template 300-A may also include an application logo element 316 for use in providing application-specific or application-type specific branding to the displayed user interface. A nomadic application may utilize the elements of the user interface template 300-A to display content on the VCS 1. For example, each of the elements 306-316 may be associated with a predefined identifier (e.g., a string, an unsigned long, a reference to an object, etc.) that may be utilized by the nomadic application to specify content to be included in the respective element.

FIG. 3B illustrates an alternate user interface template 300-B also supporting a main content section 302 and a plurality of minor content elements 304, but having a different user interface layout. While the layout of elements in the template 300-B differs from the layout of the template 300-A, the templates 300-A and 300-B each are configured to present the same user interface elements 306-316. Moreover, each of the elements 306-316 in the template 300-A may be assigned the same predefined identifier as the respective elements 306-316 in the template 300-B. As the nomadic application may be configured to manipulate the user interface of the VCS 1 according to the identifiers associated with the elements 306-316, the nomadic application may provide content to the VCS 1 without regard to the specifics of the layout of the template 300 selected for use by the VCS 1.

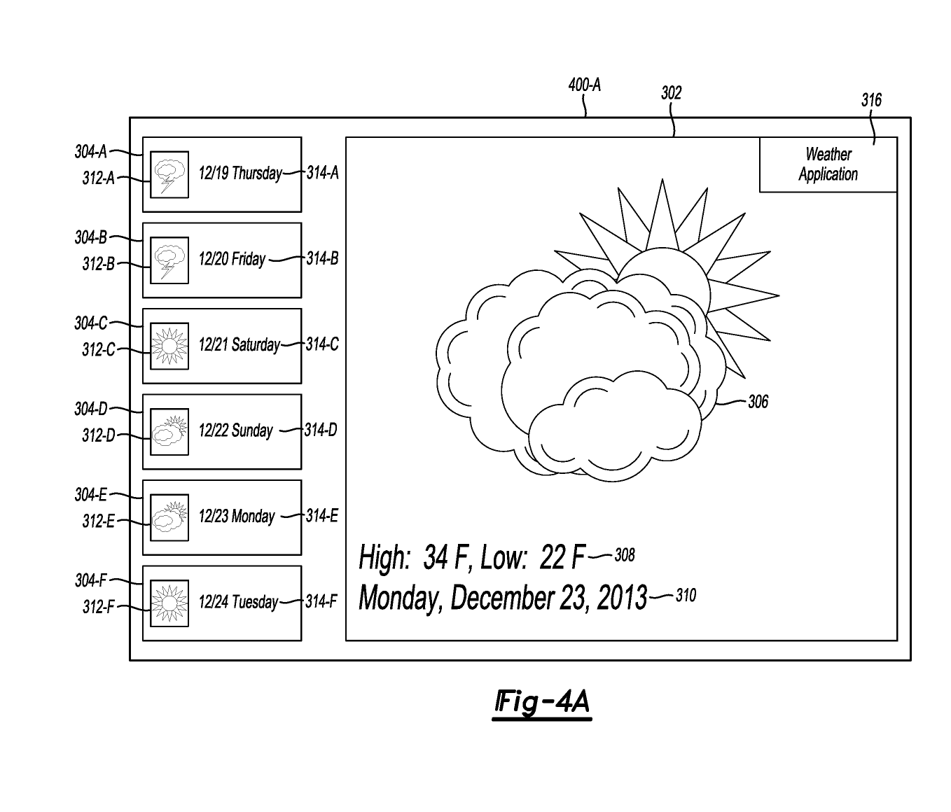

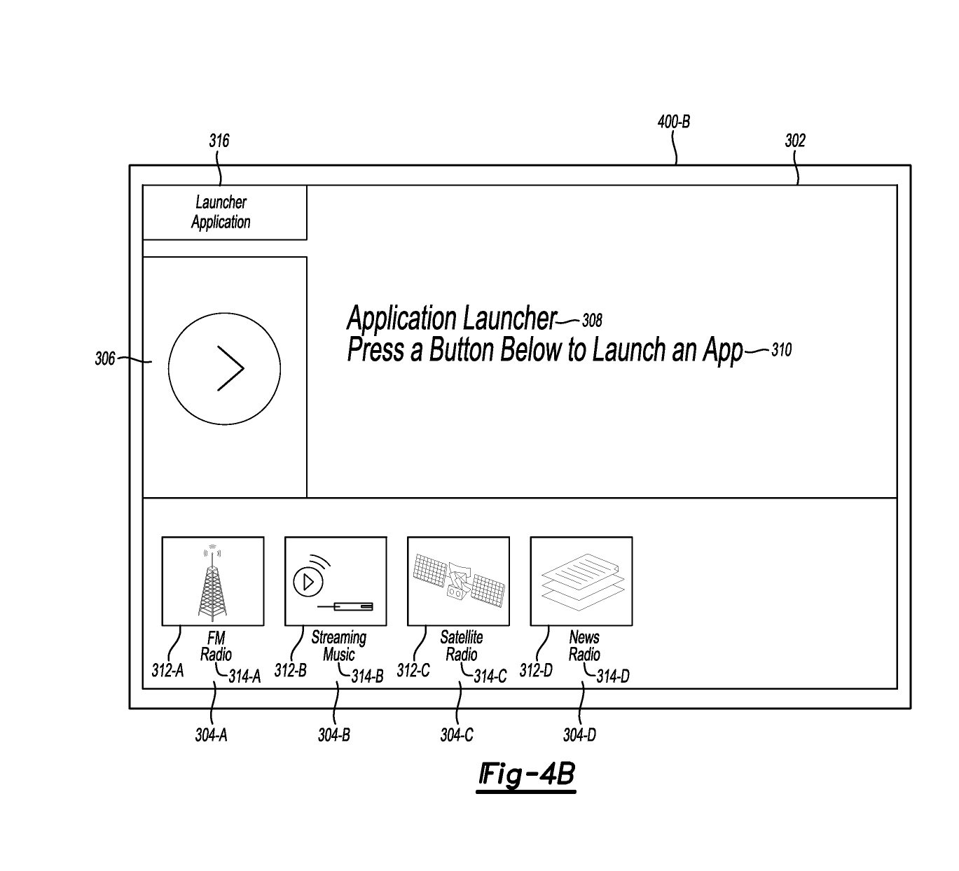

FIG. 4A illustrates an exemplary user interface 400-A of a weather-type application applying the template 300-A illustrated in FIG. 3A. As shown, an exemplary weather application may utilize the main content section 302 to display weather details for a chosen current day, and the plurality of minor content elements 304 to display a high-level multiple day weather forecast. The minor content elements 304 may be selectable, such that selection of a minor content element 304 displays weather details for the selected day in the main content section 302. For instance, the weather details for December 23^{rd} may be presented in the main content section 302 upon selection of the fifth minor content element 304-E. The template 300-A may be particularly well-suited to weather-type applications, as the template 300-A includes an arrangement of minor content elements 304 with adequate space for icon representations of the daily weather in the image sub-elements 312, as well as adequate textual room in the label sub-elements 314 to allow for the display of the corresponding days of the week.

FIG. 4B illustrates an exemplary user interface 400-B of a launcher-type application applying the template 300-B illustrated in FIG. 3B. As shown, an audio source launcher application may utilize the main content section 302 to display instructions related to use of the user interface, and may utilize the plurality of minor content element 304 as buttons indicating possible audio sources. The minor content elements 304 may be selectable, such that selection of a minor content element 304 invokes the corresponding audio source. For instance, selection of the minor content element 304-C may select the satellite radio audio source. As compared to the template 300-A the template 300-B may be preferred for use by launcher applications, as the template 300-B includes larger image sub-elements 312 facilitating easier identification of audio sources than may be possible using the smaller image sub-elements 312 of another template, such as the template 300-A.

Moreover, the exemplary user interface 400-B further illustrates customization of element visibility in the template 300-B. For instance, while the template 300-B as illustrated includes six minor content element 304 (i.e., elements 304-A through 304-F), the launcher application being displayed only has four selections, not six. When updating the user interface, the launcher application may specify content for the first four minor content elements 304, but may return a special value such as zero, NULL, or some other predefined value for the remaining minor content elements 304. Based on the information received by the VCS 1 from the launcher application, the VCS 1 may hide the remaining minor content elements 304 for which no data is available (e.g., minor content elements 304-E and 304-F). This provides for a measure of customization to the user interface 400-B displayed according to the template 300-B, to allow the user interface 400-B to appear more specifically designed than may be possible with a displayed template 300 including empty and unavailable controls. It should also be noted that in some cases the nomadic application may require more than six minor content element 304, and in such cases the template 300-B may allow for the addition of more minor content elements 304 that may be scrolled to by a user of the application.

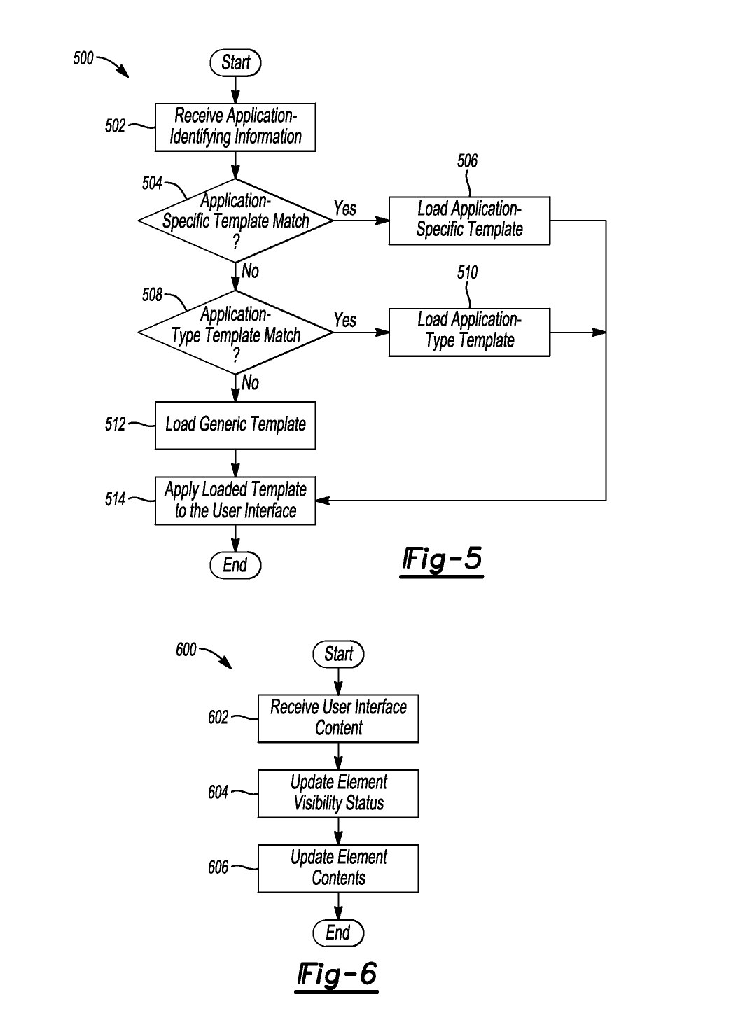

FIG. 5 illustrates an exemplary process 500 for applying a user interface template 300 to a nomadic application. As one possibility, the process 500 may be implemented using software code contained within the VCS 1. In other embodiments, the method 500 may be implemented in other vehicle controllers, or distributed amongst multiple vehicle controllers.

At block 502, the VCS 1 receives application-identifying information related to the nomadic application. For example, as part of the application negotiation process, the nomadic application connecting to the VCS 1 may specify application-identifying information. As one example, the application-identifying information may include an application identifier that uniquely identifies the nomadic application to the VCS 1. Additionally or alternately, the application-identifying information may include a category identifier indicative of a category of application with which the application is associated (e.g., music, weather etc.).

At decision point 504, the VCS 1 determines whether the application-identifying information matches an application-specific template 300. For example, VCS 1 may be configured to maintain a plurality of templates 300 (e.g., the templates 300-A and 300-B, etc.), as well as an association of application identifiers with templates 300 that are application-specific templates 300. If an application identifier is received in the application-identifying information, the VCS 1 may query the maintained plurality of templates 300 based on the application identifier to determine whether the VCS 1 is storing an application-specific template 300 corresponding to the application identifier. If a corresponding application-specific template 300 is identified, control passes to block 506. Otherwise, control passes to decision point 508.

At block 506, the VCS 1 loads the corresponding application-specific template 300 from template 300 storage. After block 506, control passes to block 514.

At decision point 508, the VCS 1 determines whether the application-identifying information matches an application-type template 300. For example, VCS 1 may be configured to maintain a plurality of templates 300 (e.g., the templates 300-A and 300-B, etc.), as well as an association of application-type identifiers with templates 300 that are application-type templates 300. If an application-type identifier is received in the application-identifying information, the VCS 1 may query the maintained plurality of templates 300 based on the application-type identifier to determine whether the VCS 1 is storing an application-type specific template 300 corresponding to the application-type identifier. As another possibility, if an application identifier is received in the application-identifying information, the VCS 1 may identify an application-type identifier based on the application identifier (e.g., according to a mapping of application identifiers to corresponding application types), and may further query the maintained plurality of templates 300 based on the application-type identifier to determine whether the VCS 1 is storing an application-type specific template 300 corresponding to the application-type identifier. If a corresponding application-type specific template 300 is identified, control passes to block 510. Otherwise, control passes to block 512.

At block 510, the VCS 1 loads the corresponding application-type specific template 300 from template 300 storage. After block 510, control passes to block 514.

At block 512, the VCS 1 loads a generic template 300 from template 300 storage for those applications not otherwise matching an application-specific or application-type specific template 300. After block 512, control passes to block 514.

At block 514, the VCS 1 applies the loaded template 300 to the user interface. For example, the loaded template 300 may be used to present content from the nomadic application in a user interface 400 in a format suitable for in-vehicle applications. After block 514, the process 500 ends.

FIG. 6 illustrates an exemplary process 600 for updating a user interface 400 of a nomadic application according to an applied user interface template 300. As with the process 500, the process 600 may be implemented using software code contained within the VCS 1, in other vehicle controllers, or distributed amongst multiple vehicle controllers.

At block 602, the VCS 1 receives user interface content. For example, the nomadic application may utilize the elements of the applied user interface template 300 to display content on the VCS 1. As one possibility, each of the elements 306-316 may be associated with a predefined identifier (e.g., a string, an unsigned long, a reference to an object, etc.) that may be utilized by the nomadic application to specify content to be included in the respective element.

At block 604, the VCS 1 updates element visibility in the user interface 400. For example, the nomadic application may specify content for only a portion of the four minor content elements 304, but may return a special value such as zero, NULL, or some other predefined value for the remaining minor content elements 304. Based on the information received by the VCS 1 from the application, the VCS 1 may hide the remaining minor content elements 304 for which no data is available. This provides for a measure of customization to the user interface 400 displayed according to the template 300, to allow the user interface 400 to appear more specifically designed than may be possible with a displayed template 300 including empty and unavailable controls.

At block 606, the VCS 1 updates element content in the user interface 400. For example, the VCS 1 may update the visible elements based on the content specified by the nomadic application. Thus, as the nomadic application may be configured to manipulate the user interface of the VCS 1 according to the identifiers associated with the elements 306-316, the nomadic application may provide content to the VCS 1 without regard to the specifics of the layout of the template 300 selected for use by the VCS 1. After block 606, the process 600 ends.

Referring again to FIGS. 5-6, the vehicle and its components illustrated in FIG. 1 and FIG. 2 are referenced throughout the discussion of the processes 500 and 600 to facilitate understanding of various aspects of the present disclosure. The processes 500 and 600 may be implemented through a computer algorithm, machine executable code, or software instructions programmed into a suitable programmable logic device(s) of the vehicle, such as the vehicle control module, the hybrid control module, another controller in communication with the vehicle computing system, or a combination thereof. Although the various steps shown in the process 500 and 600 appear to occur in a chronological sequence, at least some of the steps may occur in a different order, and some steps may be performed concurrently or not at all.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A computer-implemented method comprising:
matching application-identifying information of an application to one of a plurality of available user interface templates, each user interface template defining a presentation of common user interface elements included in each of the templates; and
providing content from the application in the user interface formatted according to the presentation of the matching user interface template.

2. The method of claim 1, wherein the application-identifying information includes at least one of a category of the application and a unique identifier of the application.

3. The method of claim 1, wherein the application is executed by a nomadic device in communication with an infotainment unit, and further comprising receiving the application-identifying information by the infotainment unit from the nomadic device.

4. The method of claim 3, further comprising receiving the application-identifying information by the infotainment unit during application startup.

5. The method of claim 1, further comprising matching the application to a generic user interface template when the application-identifying information fails to match to a user interface template corresponding to the application-identifying information.

6. The method of claim 1, wherein the plurality of available user interface templates includes at least two of: an internet radio application template, a navigation application template, a weather application template, a traffic application template, a music application template, a social media application template, and a generic catch-all template.

7. The method of claim 1, wherein the application is one of an internet radio application, a navigation application, a weather application, a traffic application, a music application, or a social media application.

8. A system including:
at least one controller configured to:
match application-identifying information of an application to one of a plurality of available user interface templates, each user interface template defining a presentation of common user interface elements included in each of the templates; and
provide content from the application in the user interface formatted according to the presentation of the matching user interface template.

9. The system of claim 8, wherein the application-identifying information includes at least one of a category of the application and a unique identifier of the application.

10. The system of claim 8, wherein the application is executed by a nomadic device in communication with an infotainment unit, and the at least one controller is further configured to receive the application-identifying information by the infotainment unit from the nomadic device.

11. The system of claim 10, wherein the at least one controller is further configured to receive the application-identifying information by the infotainment unit during application startup.

12. The system of claim 8, wherein the at least one controller is further configured to match the application to a generic user interface template when the application-identifying information fails to match to a user interface template corresponding to the application-identifying information.

13. The system of claim 8, wherein the plurality of available user interface templates includes at least two of: an internet radio application template, a navigation application template, a weather application template, a traffic application template, a music application template, a social media application template, and a generic catch-all template.

14. The system of claim 8, wherein the application is one of an internet radio application, a navigation application, a weather application, a traffic application, a music application, or a social media application.

15. A non-transitory computer readable medium comprising instructions configured to cause at least one controller to:
match application-identifying information of an application to one of a plurality of available user interface templates, each user interface template defining a presentation of common user interface elements included in each of the templates; and
provide content from the application in the user interface formatted according to the presentation of the matching user interface template.

16. The computer readable medium of claim 15, wherein the application-identifying information includes at least one of a category of the application and a unique identifier of the application.

17. The computer readable medium of claim 15, wherein the application is executed by a nomadic device in communication with an infotainment unit, and the at least one controller is further configured to receive the application-identifying information by the infotainment unit from the nomadic device.

18. The computer readable medium of claim 17, wherein the at least one controller is further configured to receive the application-identifying information by the infotainment unit during application startup.

19. The computer readable medium of claim 15, wherein the at least one controller is further configured to match the application to a generic user interface template when the application-identifying information fails to match to a user interface template corresponding to the application-identifying information.

20. The computer readable medium of claim 15, wherein the plurality of available user interface templates includes at least two of: an internet radio application template, a navigation application template, a weather application template, a traffic application template, a music application template, a social media application template, and a generic catch-all template.
